(19) United States
(12) Patent Application Publication
(10) Pub. No.: US 2026/0251797 A1
(43) Pub. Date: Aug. 27, 2026

(54) SYSTEM FOR RECOGNIZING INSIDE STRUCTURE OF TUNNEL BY USING LiDAR POINT DATA AND ARTIFICIAL INTELLIGENCE MODULE AND METHOD IMPLEMENTING THE SAME

(71) Applicants: Hyundai Motor Company, Seoul (KR); Kia Corporation, Seoul (KR)

(72) Inventors: Jae In LEE, Hwaseong-Si (KR); Nam Gyun KIM, Hwaseong-Si (KR)

(21) Appl. No.: 19/285,148

(22) Filed: Jul. 30, 2025

(30) Foreign Application Priority Data
Feb. 27, 2025 (KR) 10-2025-0026233

(51) Int. Cl. G01S 17/931; G01S 7/48; G05D 1/242

(52) U.S. Cl. CPC G01S 17/931; G01S 7/4802; G05D 1/242

(57) ABSTRACT

An apparatus of a vehicle may comprise a processor and a memory storing at least one instruction. When executed by the processor communicating with the memory, the instruction is configured to cause the apparatus to generate, based on sensor data from a sensor of the vehicle, point cloud data representing a surrounding environment of the vehicle, detect a plurality of candidate points from the point cloud data by excluding a point based on a height being less than or equal to a first threshold value, determine a slope for each of the plurality of candidate points, exclude each candidate point having a slope greater than or equal to a second threshold value, identify the tunnel ceiling, output a signal, and control autonomous driving.

### CROSS-REFERENCE TO RELATED APPLICATION

This application claims the benefit of priority to Korean Patent Application No. 10-2025-0026233, filed in the Korean Intellectual Property Office on Feb. 27, 2025, the entire contents of which are incorporated herein by reference.

### TECHNICAL FIELD

The present disclosure relates to a system and a method for recognizing an inside structure of a tunnel by using LiDAR point data and an artificial intelligence (AI) module, and more particularly, relate to a system and a method for recognizing the inside structure of a tunnel by using AI such that a LiDAR mounted on a vehicle driving inside the tunnel is capable of accurately recognizing an upper portion (in particular, a ceiling structure) of the tunnel.

### BACKGROUND

The matters described in this Background section are only for enhancement of understanding of the background of the disclosure, and should not be taken as acknowledgment that they correspond to prior art already known to those skilled in the art.

A variety of sensors and artificial intelligence (AI) technologies may be used to support an autonomous driving function of a vehicle. For example, search on an object in front of a moving vehicle, a distance between the object and the vehicle, and an algorithm in which the vehicle responds to specific situations to ensure safety is being considered.

Accordingly, high-performance sensors such as Light Detection and Ranging (LiDAR) that recognizes surrounding environments by using laser beams, Radio Detection and Ranging (RADAR) that uses radio waves, an ultrasonic sensor, a fisheye camera capable of capturing 360-degree images, a multifocal lens, and a global positioning system (GPS) are being installed in vehicles.

As such, a super sensor vehicle may be implemented by aggregating measurement results obtained from a plurality of sensors. In self-driving (autonomous driving), the concept of a super sensor refers to a technology that accurately recognizes surrounding environments for comfort or safety by combining measured values from a variety of sensors rather than relying on individual sensors. Here, with the addition of information and communications technology (ICT) and cloud technology, sensors required for autonomous driving, and AI algorithms related thereto are becoming more sophisticated than ever, to increase the reliability of the determination of vehicle sensors by remotely accumulating data from numerous fleets of vehicles without targeting only a single vehicle and training an AI server and a database.

Among the sensors, the LiDAR sensor for recognizing external environments recognizes various objects on a road during autonomous driving by emitting a laser beam, and measuring the intensity of the laser and the time required for the laser beam to be reflected from surrounding objects.

Object recognition using the LiDAR and the AI algorithm is not perfect. Even though the sensing performance of the LiDAR is advanced, and AI technology is developed, a tunnel ceiling may be misrecognized as an object placed in front of a vehicle when the vehicle is driving inside a tunnel.

Because tunnel driving is a situation where special attention needs to be paid to safety, a technology capable of accurately recognizing an inner structure of the tunnel is considered.

### SUMMARY

The present disclosure has been made to solve the above-mentioned problems.

According to the present disclosure, an apparatus of a vehicle, the apparatus may comprise a processor, and a memory storing at least one instruction that, when executed by the processor communicating with the memory, is configured to cause the apparatus to generate, based on sensor data from a sensor of the vehicle, point cloud data representing a surrounding environment of the vehicle, detect, from the point cloud data, a plurality of candidate points by excluding a point from among points input from an upper channel of the sensor, based on a height of the point being less than or equal to a first threshold value, wherein the plurality of candidate points are points estimated to correspond to a tunnel ceiling, determine a slope for each of the plurality of candidate points, exclude, from the plurality of candidate points, each candidate point having the determined slope being greater than or equal to a second threshold value, identify, based on the remaining candidate points and based on a learning model stored in the memory, the tunnel ceiling, output a signal indicating the identified tunnel ceiling, and control, based on the signal, autonomous driving of the vehicle.

The apparatus, wherein at least one instruction, when executed by the processor communicating with the memory, is configured to cause the apparatus to identify an adjacent point located in a traveling direction of the vehicle, and wherein the slope is determined based on a height difference between a candidate point and the adjacent point and based on a horizontal distance between the candidate point and the adjacent point, and identify, based on the remaining candidate points input into the learning model, the tunnel ceiling.

The apparatus, wherein the second threshold value is a variable in units of frame over time, and wherein the second threshold value is determined based on the following equation slopeₜₕ=weightₜₕ*slopeₜ₋₁+ (1−weightₜₕ)*slopeₜ, and wherein the slopeₜₕ is a second threshold value applied at time ‘t’, the weightₜₕ is a weight measured by using empirical data, the slopeₜ is a slope of a candidate point measured at time ‘t’, and the slopeₜ₋₁ is a slope of the candidate point measured at time ‘t−1’.

The apparatus, wherein the at least one instruction, when executed by the processor communicating with the memory, is configured to cause the apparatus to recognize, as a tunnel ceiling point, a candidate point whose measured slope is less than the second threshold value corresponding to a ceiling determination value, even after the slopeₜₕ reaches the ceiling determination value.

The apparatus, wherein the at least one instruction, when executed by the processor communicating with the memory, is configured to cause the apparatus to generate a noise flag for each candidate point excluded from the plurality of candidate points.

The apparatus, wherein the at least one instruction, when executed by the processor communicating with the memory, is configured to cause the apparatus to detect the plurality of candidate points based on applying a width threshold value and a length threshold value to the points input from the upper channel of the sensor.

The apparatus, wherein the at least one instruction, when executed by the processor communicating with the memory, is configured to cause the apparatus to, before detecting the plurality of candidate points, determine, based on a slope of a first point satisfying a predetermined ground slope threshold value, the first point as a ground point, wherein the first point is from among points input from a lower channel of the sensor, and wherein the ground point is a point estimated not to correspond to the tunnel ceiling.

The apparatus, wherein the at least one instruction, when executed by the processor communicating with the memory, is configured to cause the apparatus to generate history information about misrecognition, wherein the misrecognition corresponds to a case where there is a point, which is incorrectly identified as a tunnel ceiling point of the tunnel ceiling.

The apparatus, wherein the width threshold value, the length threshold value, and the first threshold value are set differently for each tunnel of a plurality of tunnels having tunnel ceilings.

The apparatus, wherein the width threshold value, the length threshold value, and the first threshold value are set differently for each of a plurality of predefined sections within a tunnel having the tunnel ceiling.

According to the present disclosure, a method performed by an apparatus of a vehicle, the method may comprise detecting a plurality of candidate points by excluding a point from among points input from an upper channel of a sensor of the vehicle, based on a height of the point being less than or equal to a first threshold value, and wherein the plurality of candidate points are points estimated to correspond to a tunnel ceiling, determining a slope for each of the plurality of candidate points, excluding, from the plurality of candidate points, each candidate point having the determined slope being greater than or equal to a second threshold value, identifying, based on the remaining candidate points and based on a learning model stored in a memory of the vehicle, the tunnel ceiling, outputting a signal indicating the identified tunnel ceiling, and controlling, based on the signal, autonomous driving of the vehicle.

The method, wherein the determining of the slope for each of the plurality of candidate points may comprise identifying an adjacent point located in a traveling direction of the vehicle, based on a height difference between a candidate point and the adjacent point and based on a horizontal distance between the candidate point and the adjacent point, determining, as the slope, a slope between the candidate point and the adjacent point, and identifying, based on the remaining candidate points input into the learning model, the tunnel ceiling.

The method, wherein the second threshold value is a variable in units of frame over time, and wherein the second threshold value is determined based on the following equation slopeₜₕ=weightₜₕ*slopeₜ₋₁+ (1−weightₜₕ)*slopeₜ, and wherein the slopeₜₕ is a second threshold value applied at time ‘t’, the weightₜₕ is a weight measured by using empirical data, the slopeₜ is a slope of a candidate point measured at time ‘t’, and the slopeₜ₋₁ is a slope of the candidate point measured at time ‘t−1’.

The method may further comprise recognizing as a tunnel ceiling point, a candidate point whose measured slope is less than the second threshold value corresponding to a ceiling determination value even after the slopeₜₕ reaches the ceiling determination value.

The method may further comprise generating a noise flag for each candidate point excluded from the plurality of candidate points.

The method, wherein the detecting of the plurality of candidate points may comprise detecting the plurality of candidate points by applying a width threshold value and a length threshold value to the point input from the upper channel of the sensor.

The method may further comprise before the detecting of the plurality of candidate points, determining, based on a slope of a first point satisfying a predetermined ground slope threshold value, the first point as a ground point, wherein the first point is from among points input from a lower channel of the sensor, and wherein the ground point is a point estimated not to correspond to the tunnel ceiling.

The method may further comprise generating history information about misrecognition, wherein the misrecognition corresponds to a case where there is a point, which is incorrectly identified as a tunnel ceiling point of the tunnel ceiling.

According to the present disclosure, a method performed by an apparatus of a vehicle, the method may comprise obtaining, from a sensor of the vehicle, data representing a surrounding environment of the vehicle, filtering the data to exclude points having a height less than or equal to a first threshold value, to generate a plurality of candidate points, for each of the plurality of candidate points, identifying an adjacent point located in a traveling direction of the vehicle and determining a slope between a candidate point and the adjacent point, wherein the slope is determined based on a height difference between the candidate point and the adjacent point and based on a horizontal distance between the candidate point and the adjacent point, removing, from the plurality of candidate points, each candidate point having a slope greater than or equal to a second threshold value, to obtain a plurality of ceiling points, identifying, based on the plurality of ceiling points input into a learning model stored in a memory of the vehicle, a tunnel ceiling, generating a signal indicating the identified tunnel ceiling, and controlling, based on the signal, autonomous driving of the vehicle.

The method may further comprise, prior to generation of the plurality of candidate points, identifying, based on a ground slope threshold value, one or more ground points from the data, and excluding the one or more ground points from the data.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of the overall system for automatically recognizing an object and controlling a vehicle for the purpose of autonomous driving, according to an example of the present disclosure;

FIG. 2 shows an example of an inside structure of a tunnel, to which a system and a method for recognizing an inside structure of a tunnel by using point data recognized from LiDAR and an AI module are applied, according to an example of the present disclosure;

FIG. 3 shows an example of an algorithm for recognizing an inside structure of a tunnel by using point data recognized from LiDAR and an AI module, according to an example of the present disclosure;

FIG. 4 shows an example of a slope measurement principle performed to determine a point corresponding to the ceiling of a tunnel, according to an example of the present disclosure;

FIG. 5 shows an example of a principle by which a tunnel ceiling is capable of being accurately measured over time when an algorithm for recognizing the inside structure of a tunnel is applied by using point data recognized from LiDAR and an AI module, according to an example of the present disclosure;

FIG. 6 shows an example of an actual experimental result in which misrecognition inside a tunnel is improved by applying an algorithm for recognizing the inside structure of a tunnel by using point data recognized from LiDAR and an AI module; and

FIG. 7 shows an example of a computing system for autonomous vehicle control and object recognition operations, according to an example of the present disclosure.

### DETAILED DESCRIPTION

Hereinafter, some examples of the present disclosure will be described in detail with reference to the accompanying drawings. In adding reference numerals to components of each drawing, it should be noted that the same components include the same reference numerals, although they are indicated on another drawing. Furthermore, in describing the examples of the present disclosure, detailed descriptions associated with well-known functions or configurations will be omitted when they may make subject matters of the present disclosure unnecessarily obscure.

In describing elements of an example of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms used herein, including technical or scientific terms, include the same meaning as commonly understood by one of ordinary skill in the technical field to which the present disclosure belongs. It will be understood that terms used herein should be interpreted as including a meaning that is consistent with their meaning in the context of the present disclosure and the relevant art and will not be interpreted in an idealized or overly formal sense unless expressly so defined herein. For example, in the present disclosure, term “object” has substantially the same meaning as “gaegche (in Korean)”, and expressions “object” and “gaegche” are used interchangeably in the present disclosure.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICS, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., feature of recognizing a tunnel ceiling) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., feature of recognizing a tunnel ceiling) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., feature of recognizing a tunnel ceiling) described herein.

Minimum risk maneuver (MRM) operation(s) may also be controlled, for example, based on one or more features (e.g., feature of recognizing a tunnel ceiling) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., feature of recognizing a tunnel ceiling) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., feature of recognizing a tunnel ceiling) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

An autonomous driving level and/or autonomous driving activation/deactivation may also be controlled, for example, based on one or more features (e.g., feature of recognizing a tunnel ceiling) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as five second, 30 seconds, 1 minute, etc.). By changing the required user attentiveness, the driver may be required to look ahead more often (e.g., at least once in a threshold time period, such as five second, 30 seconds, 1 minute, etc.). By changing the autonomous driving level, one or more video contents may not be displayed on a display of the vehicle.

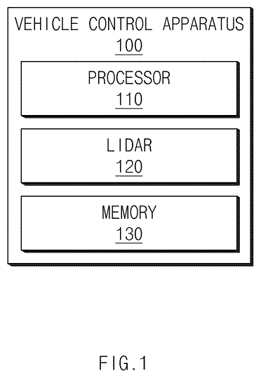

FIG. 1 shows an example of the overall system for automatically recognizing an object and controlling a vehicle for the purpose of autonomous driving, according to an example of the present disclosure.

Referring to FIG. 1, a vehicle control apparatus 100 according to an example of the present disclosure may be implemented inside or outside a vehicle, and some of the components included in the vehicle control apparatus 100 may be implemented inside or outside the vehicle. At this time, the vehicle control apparatus 100 may be integrated with internal control units of a vehicle and may be implemented with a separate device so as to be coupled with control units of the vehicle by means of a separate connection interface. For example, the vehicle control apparatus 100 may further include components not shown in FIG. 1 (e.g., a power supply circuit, a wireless communication circuit, or a GPS receiver, etc.).

The vehicle control apparatus 100 according to an example may include a processor 110, a LiDAR 120, and a memory 130. The processor 110, the LiDAR 120, or the memory 130 may be electronically and/or operably coupled with each other by an electronic component including a communication bus.

Hereinafter, the fact that pieces of hardware are coupled operably may include the fact that a direct and/or indirect connection between pieces of hardware is established by wired and/or wirelessly such that a second hardware is controlled by a first hardware among the pieces of hardware.

Although different blocks are shown, an example is not limited thereto. For example, some of the pieces of hardware in FIG. 1 may be included in a single integrated circuit including a system on chip (SoC). The type and/or number of hardware components included in the vehicle control apparatus 100 is not limited to that shown in FIG. 1. For example, the vehicle control apparatus 100 may include only some of the pieces of hardware shown in FIG. 1 (e.g., a processor and a LiDAR sensor without a dedicated memory, etc.).

The vehicle control apparatus 100 according to an example may include hardware for processing data based on one or more instructions. For example, the hardware for processing data may include the processor 110. For example, the hardware for processing data may include an arithmetic and logic unit (ALU), a floating point unit (FPU), a field programmable gate array (FPGA), a central processing unit (CPU), and/or an application processor (AP). The processor 110 may include the architecture of a single-core processor, or may include the architecture of a multi-core processor including a dual core, a quad core, a hexa core, or an octa core (e.g., 8-core CPUs used in edge computing modules for autonomous vehicles, etc.).

According to an example, the processor 110 may include at least one of a graphic processing unit (GPU), or a neural processing unit (NPU), or any combination thereof. For example, the GPU may be referred to as a “visual processing unit (VPU)”. For example, the NPU may be referred to as a “neural network processing unit” (e.g., an AI accelerator used for real-time inference on LiDAR point clouds, etc.).

The vehicle control apparatus 100 according to an example may include a depth sensor for detecting an external object. For example, the depth sensor for detecting an external object may include at least one of a time of flight (ToF) sensor, the LiDAR 120, a structured light sensor, an ultrasonic sensor, an infrared sensor, radio detection and ranging (RADAR), or an optical distance sensor, or any combination thereof (e.g., LiDAR and RADAR used together for redundancy, etc.). Hereinafter, for convenience of description, the following descriptions will focus on LiDAR.

The vehicle control apparatus 100 according to an example may include the LiDAR 120 that obtains a plurality of points based on a pulsed laser signal (e.g., a time-of-flight laser pulse, a frequency-modulated continuous wave signal, or a hybrid scanning signal, etc.). For example, the LiDAR 120 may obtain datasets obtained by identifying objects surrounding the vehicle control apparatus 100 (or a vehicle including the vehicle control apparatus 100). For example, the LiDAR 120 may identify at least one of a location of the surrounding object, a movement direction of the surrounding object, or the speed of the surrounding object, or any combination thereof based on the pulsed laser signal emitted from the LiDAR 120 being reflected and returned by the surrounding object (e.g., identifying the rear end of a vehicle ahead, a tunnel wall, or an overhead traffic sign, etc.).

For example, the LiDAR 120 may obtain datasets for expressing an external object in the space defined by an x-axis, a y-axis, and a z-axis based on a pulsed laser signal reflected from surrounding objects (e.g., vehicles, tunnel walls, road surfaces, or overhead structures, etc.). For example, the LiDAR 120 may obtain datasets including a plurality of points in the space, which is formed by the x-axis, the y-axis, and the z-axis, based on receiving the pulsed laser signal at a designated period (e.g., every 100 milliseconds, 10 Hz, or frame-by-frame in a rotating LiDAR system, etc.). For example, the plurality of points may include points representing an external object within a three-dimensional virtual coordinate system. The three-dimensional virtual coordinate system may include at least one of a vehicle coordinate system, a world coordinate system, or a LiDAR coordinate system, or any combination thereof (e.g., for aligning point clouds to a global map, performing object tracking, or calculating slopes relative to the vehicle's direction of travel, etc.). However, an example of the three-dimensional virtual coordinate system is not limited to those described above.

The memory 130 of the vehicle control apparatus 100 according to an example may include a hardware component for storing data and/or instructions that are to be input and/or output to the processor 110 of the vehicle control apparatus 100. For example, the memory 130 may include a volatile memory including a random-access memory (RAM), and/or a non-volatile memory including a read-only memory (ROM) (e.g., for temporarily storing LiDAR frame data or persistently storing AI models and configuration files, etc.).

For example, the volatile memory may include at least one of a dynamic RAM (DRAM), a static RAM (SRAM), a cache RAM, or a pseudo SRAM (PSRAM), or any combination thereof. For example, the non-volatile memory may include at least one of a programmable ROM (PROM), an erasable PROM (EPROM), an electrically erasable PROM (EEPROM), a flash memory, a hard disk, a compact disk, a solid state drive (SSD), or an embedded multi-media card (eMMC), or any combination thereof e.g., an SSD for logging LiDAR scans during tunnel navigation, etc.).

One or more instructions indicating an arithmetic operation and/or an operation to be performed on data by the processor 110 of the vehicle control apparatus 100 may be stored in the memory 130 of the vehicle control apparatus 100. A set of one or more instructions may be referred to as a “program”, “firmware”, an “operating system”, a “process”, a “routine”, a “sub-routine”, and/or an “application” (e.g., a tunnel recognition module, a slope filtering routine, or a LiDAR calibration program, etc.).

Hereinafter, the fact that an application is installed in the vehicle control apparatus 100 may mean that the one or more instructions provided in a form of an application are stored in the memory 130, and may mean that one or more applications are stored in a format (e.g., a file with an extension specified by the operating system of the vehicle control apparatus 100) that is executable by the processor 110 of the vehicle control apparatus 100.

For example, the memory 130 may include a first neural network model for detecting an object. For example, the memory 130 may include a second neural network model for outputting the types of the plurality of points obtained by the LiDAR 120, and/or scores of the plurality of points (e.g., classification confidence values, segmentation masks, or instance IDs, etc.).

In an example, the processor 110 may obtain, based on the plurality of points obtained through the LiDAR 120 and the first neural network model stored in the memory 130, at least one of a first virtual box for representing a target object, or a first class representing the type of the target object, or any combination thereof.

For example, the processor 110 may obtain at least one of the first virtual box representing the target object, or the first class representing the type of the target object, or any combination thereof based on inputting the plurality of points into the first neural network model. For example, the first neural network model may include an object detection model (e.g., PointPillars, PV-RCNN, or SECOND, etc.). For example, the target object may include an external object placed within a specified distance from the vehicle control apparatus 100 (or a host vehicle including the vehicle control apparatus 100) (e.g., another vehicle, a pedestrian, a tunnel ceiling, or a traffic cone, etc.). For example, the target object may include an object that is identified by the vehicle control apparatus 100 and is continuously tracked across consecutive LiDAR frames. For example, the type of the target object may include a plurality of types for classifying the target object based on shape, size, motion, or reflection characteristics, etc. For example, the type of the target object may include at least one of a first type representing the ground, or a second type representing a type different from the ground (e.g., a tunnel ceiling, a vertical wall, a vehicle, or a pedestrian, etc.), or any combination thereof. The type of the target object is not limited to the examples described above. For example, the type of the target object may include, but is not limited to, at least one of a third type representing a person, or a fourth type representing a vehicle, or any combination thereof (e.g., a tunnel wall, an overhead ceiling surface, a traffic sign, or a stationary obstacle, etc.).

In an example, the processor 110 may obtain at least one of first partial points corresponding to at least part of the target object among the plurality of points, or a second class identified by the first partial points and representing the type of the target object, or any combination thereof based on the plurality of points and a second neural network model. For example, the second neural network model may include a segmentation model (e.g., PointNet++, RangeNet++, or KPConv, etc.).

For example, the second neural network model may include a neural network model for obtaining the types of the plurality of points (e.g., semantic labels or instance IDs) and scores of the plurality of points (e.g., confidence scores, probability values, or relevance rankings, etc.).

For example, the processor 110 may obtain the first partial points corresponding to at least part of the target object among the plurality of points based on inputting the plurality of points into the second neural network model. For example, the processor 110 may identify the types of the plurality of points based on inputting the plurality of points into the second neural network model and processing the resulting output of the second neural network model (e.g., semantic labels such as ground, ceiling, vehicle, or pedestrian, etc.). For example, the processor 110 may obtain the first partial points corresponding to at least part of the target object among the plurality of points based on the type assigned to each of the plurality of points.

In an example, the processor 110 may perform a first specified algorithm on the plurality of points. For example, the processor 110 may perform the first specified algorithm for classifying the type of each of the plurality of points on the plurality of points (e.g., ground, ceiling, obstacle, or background, etc.). For example, the processor 110 may classify second partial points corresponding to a specified type among the plurality of points. For example, the specified type may include a type representing the ground (e.g., road surface or tunnel floor, etc.).

For example, on the basis of performing the first specified algorithm on the plurality of points, the processor 110 may obtain (or identify) the first partial points by classifying the second partial points corresponding to the specified type and excluding those second partial points from further processing of the plurality of points (e.g., removing ground points before identifying overhead tunnel features, etc.).

In an example, the processor 110 may obtain at least one of a partial class for obtaining a second class, or a score of each of the plurality of points, or any combination thereof based on inputting the plurality of points to the second neural network model (e.g., to assist with fine-grained classification or confidence-based filtering, etc.). For example, the processor 110 may obtain the partial class and the score of each of the plurality of points based on inputting the plurality of points to the second neural network model. For example, the partial class may include classifying the plurality of points based on an arbitrary type (e.g., based on geometry, reflectivity, or context within the tunnel, etc.).

For example, the processor 110 may fuse the partial class, the score of each of the plurality of points, and the second partial points. For example, the processor 110 may perform clustering based on fusing the partial class, the score of each of the plurality of points, and the second partial points. For example, the clustering may include grouping the first partial points corresponding to at least part of the target object (e.g., forming a connected cluster representing a tunnel ceiling, a nearby vehicle, or a pedestrian, etc.

For example, the processor 110 may obtain a point cloud for generating a second virtual box based on the first partial points. For example, the processor 110 may obtain the point cloud based on grouping the first partial points using a clustering algorithm (e.g., DBSCAN, Euclidean clustering, or region growing, etc.).

For example, the processor 110 may generate the second virtual box, which is different from the first virtual box and represents the target object, based on the point cloud. For example, the second virtual box may include a box including at least some of the first partial points (e.g., bounding a segmented ceiling surface or localized traffic sign structure, etc.).

For example, the processor 110 may identify a heading direction indicating a traveling direction of the target object based on at least one of the first partial points, or the point cloud, or any combination thereof (e.g., by calculating the principal axis of the point cluster, motion vector over time, or orientation metadata, etc.).

For example, the processor 110 may identify the location of the second virtual box in the virtual coordinate system based on at least one of the first partial points, the point cloud, or any combination thereof (e.g., by computing a centroid, axis-aligned bounding region, or weighted average position, etc.). For example, the processor 110 may identify the size of the second virtual box based on at least one of the first partial points, the point cloud, or any combination thereof (e.g., by calculating width, height, and depth of a cluster representing a tunnel ceiling or an obstacle, etc.). For example, the processor 110 may identify the second class based on at least one of the first partial points, the point cloud, or any combination thereof (e.g., classifying the object as a vehicle, wall, road surface, or tunnel ceiling, etc.). For example, the processor 110 may identify at least one of a heading direction indicating a traveling direction of the target object, a location of a second virtual box in a virtual coordinate system, a size of the second virtual box, or a second class, or any combination thereof based on at least one of the first partial points, the point cloud, or any combination thereof (e.g., using geometric fitting, centroid estimation, or deep learning-based object parsing, etc.). For example, the processor 110 may identify the heading direction of a bounding box based on at least one of the first virtual box, the first class, the heading direction of the second virtual box, the location of the second virtual box, the size of the second virtual box, the second class, or any combination thereof (e.g., using principal component analysis or motion vectors derived from temporal LiDAR data, etc.). For example, the processor 110 may identify the location of a bounding box in a virtual coordinate system based on at least one of the first virtual box, the first class, the heading direction of the second virtual box, the location of the second virtual box, the size of the second virtual box, or the second class, or any combination thereof (e.g., mapping the box to a global or vehicle-relative frame of reference, etc.). For example, the processor 110 may obtain a third class representing the type of the target object corresponding to the bounding box based on at least one of the first virtual box, the first class, the heading direction of the second virtual box, the location of the second virtual box, the size of the second virtual box, or the second class, or any combination thereof (e.g., classifying the object as static infrastructure, dynamic obstacle, or ignored structure, etc.). For example, the processor 110 may obtain at least one of the heading direction of the bounding box, the location of the bounding box in the virtual coordinate system, or the third class indicating the type of the target object corresponding to the bounding box, or any combination thereof based on at least one of the first virtual box, the first class, the heading direction of the second virtual box, the location of the second virtual box, the size of the second virtual box, or the second class, or any combination thereof (e.g., to generate final object metadata for downstream tasks such as tracking, path prediction, or collision avoidance, etc.).

For example, the processor 110 may assign a first identifier to the second virtual box for tracking the second virtual box (e.g., a unique ID such as a UUID, sequence number, or label ID, etc.). For example, the processor 110 may assign a second identifier corresponding to a first identifier to a bounding box (e.g., for cross-referencing virtual object instances over time, etc.).

For example, the processor 110 may track the bounding box by using the second identifier. For example, the processor 110 may track a target object based on identifying, in a plurality of frames, a plurality of bounding boxes including the bounding box to which the second identifier is assigned (e.g., across sequential LiDAR sweeps during tunnel traversal, etc.). For example, because the second identifier is an identifier assigned to the bounding box corresponding to the target object, the processor 110 may track the target object by identifying a plurality of bounding boxes that are assigned the second identifier across a plurality of frames (e.g., to maintain persistent tracking of a moving tunnel ceiling segment, vehicle, or pedestrian, etc.).

In an example, the processor 110 may output the bounding box corresponding to the target object based on at least one of the first virtual box, the first class, the first partial points, or the second class, or any combination thereof (e.g., to enable tracking, navigation, or collision avoidance, etc.). For example, a bounding box may include an example of the target object expressed in a virtual coordinate system in the form of a hexahedron (e.g., a rectangular prism surrounding a detected vehicle, tunnel ceiling, or static object, etc.).

Hereinafter, operations performed by a CPU, a GPU, and/or an NPU included in the processor 110 are briefly described (e.g., hardware-accelerated neural inference, point-level classification, or clustering, etc.).

In an example, the processor 110 may include at least one of the CPU, the GPU, or the NPU, or any combination thereof. For example, at least one of the GPU, or the NPU, or any combination thereof may obtain the first virtual box and the first class based on the first neural network model (e.g., by executing an object detection model trained to identify tunnel ceilings, vehicles, or obstacles, etc.). For example, at least one of the GPU or NPU may obtain the first virtual box and the first class. For example, at least one of the GPU, or the NPU, or any combination thereof may obtain a score for each of the plurality of points and a partial class for obtaining the second class based on the second neural network model (e.g., for use in tunnel interior segmentation or false-positive rejection, etc.). For example, at least one of the GPU or the NPU may obtain the score of each of the plurality of points and the partial class for obtaining the second class based on the second neural network model. For example, the CPU may classify the second partial points corresponding to a specified type among the plurality of points based on performing the first specified algorithm for classifying each type of the plurality of points (e.g., to identify and remove ground points prior to ceiling analysis, etc.).

As described above, the vehicle control apparatus 100 according to an example may include at least one processor 110. The vehicle control apparatus 100 may accurately detect the target object by detecting the target object by using at least one of the processors 110 (e.g., in real time during tunnel entry, urban driving, or object handoff across sensor modalities, etc.). Furthermore, the vehicle control apparatus 100 may reduce the load on each processor by performing parallel processes (e.g., neural inference on the NPU while tracking logic runs on the CPU, etc.).

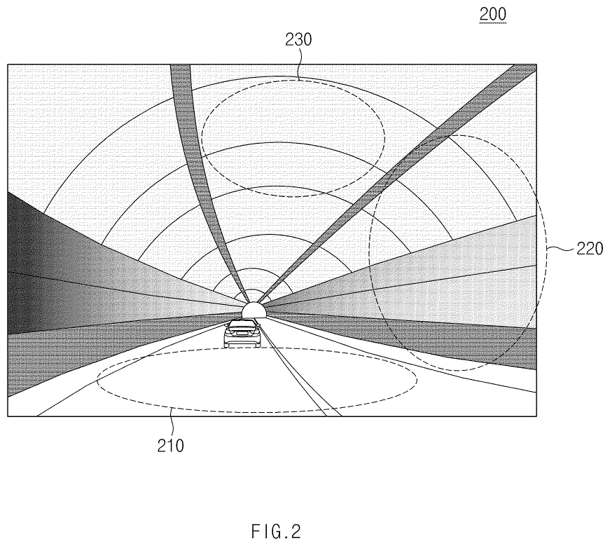

FIG. 2 shows an example of an inside structure 200 of a tunnel, to which a system and a method for recognizing an inside structure of a tunnel by using point data recognized from LiDAR and an AI module are applied, according to an example of the present disclosure (e.g., recognizing and differentiating tunnel walls, ceilings, or low-hanging elements, etc.).

As shown in FIG. 2, when a vehicle enters the tunnel 200, the vehicle may recognize objects such as another vehicle, ground 210, a tunnel wall 220, and a tunnel ceiling 230. When the tunnel ceiling 230 is low, the LiDAR 120 mounted on the vehicle may misrecognize the inside structure of a tunnel, and in particular, object recognition errors may occur (e.g., mistaking the ceiling for a road obstruction or misclassifying overhead features as blocking objects, etc.), such as a case where there is something in front of the vehicle that is blocking the vehicle's path.

For reference, the object recognition process by the LIDAR 120 and the AI module may proceed through three stages: preprocessing, segmentation, and tracking. In the present disclosure, a method of recognizing the inside structure 200 of the tunnel by the LiDAR 120 and the AI module mounted on the processor 110 is as follows.

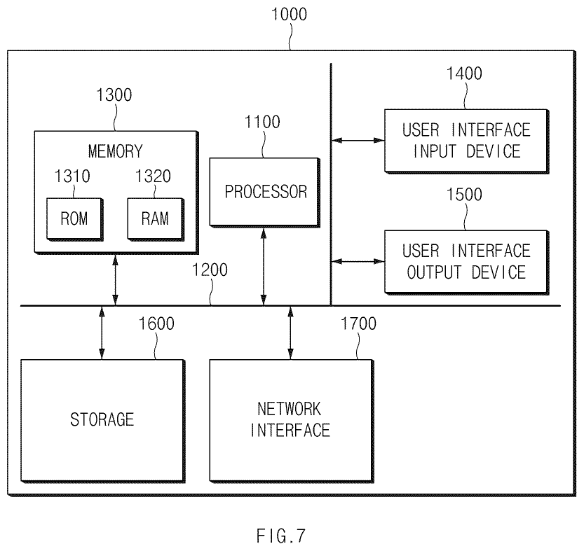

An object recognition system 1000 (see FIG. 7) according to an example of the present disclosure goes through a pre-processing process before executing an object recognition function. The pre-processing may include an operation of removing points forming the ground based on laser sensing data (i.e., raw data not processed) input from the LiDAR 120. Because the laser beam reflected from the ground may be misrecognized as though there is an object on the ground, a process of distinguishing between ground and non-ground may be performed in a pre-processing stage (e.g., ground plane estimation using RANSAC, height thresholding, or slope filtering, etc.). As needed, the process may also be performed in the segmentation stage.

For example, in AI object recognition, the pre-processing may be understood as a process in which an image processing tool of the AI module in the processor 110 removes noise from a LiDAR point cloud image and reduces the total number of points being present in the LiDAR point cloud image through a voxel down sampling technique to improve computational efficiency (e.g., reducing millions of points into uniform cubic volumes to accelerate inference, etc.).

For reference, the LiDAR point cloud image may also be displayed in a bird's eye view (BEV) mode. When LiDAR maps are created to resemble the scene as seen through a bird's eye when a bird watches a city center while a bird flies overhead, the LiDAR maps are called BEV images (e.g., top-down 2D projections used for object detection, path planning, or road marking recognition, etc.).

In other words, as described above, the LiDAR 120 generates a point for each of the numerous laser signals and calculates a distance to the point, by sending a laser beam out into environments and recording the time at which the laser beam is reflected from an object outside the environments and then is returned. The processor 110 may create a real-time LiDAR map of the surrounding environment as a BEV-type 3D map, or as a 2D map as needed, by repeatedly sending out a lot of laser beams in this way (e.g., enabling dynamic mapping and localization inside tunnels, intersections, or urban roads, etc.).

The lines or areas that appear in black and white on a LiDAR point cloud map are actually composed of countless points (each of the points is generated by the laser beam of the LiDAR 120), which is why the LiDAR sensing image is also called a LiDAR point cloud image. Of course, for example, when an RGB-D (Red, Green, Blue-Depth) sensor and a LiDAR sensor are combined, the LiDAR point cloud image may be recreated in color (e.g., to overlay RGB context on top of depth maps for enhanced object interpretation, etc.).

It is difficult for humans to perceive objects with a lot of points in the LiDAR point cloud image. However, when viewing a point cloud from a BEV perspective or in a method such as a two-dimensional plan, humans may roughly guess what the surroundings of the vehicle currently driving autonomously look like. Furthermore, for example, vehicles, buses, pedestrians, street trees, and traffic signs that are present in the LiDAR point cloud image may be recognized (e.g., based on geometric features, reflectivity, and clustering patterns, etc.). In an AI image recognition technology, these things or people are called objects. Each object may be classified into classes belonging to a group with specific characteristics, such as a vehicle class or a bus class, a pedestrian class, or a traffic sign class, etc.

Identifying a class of an object such as a vehicle class, a bus class, a pedestrian class, or a sign class, etc., in the LiDAR point cloud image requires the help of a deep AI neural network. To find objects in the LiDAR point cloud image through an AI neural network and to identify classes of the objects, AI training needs to be performed first.

For example, a dataset called PANDASET™ includes over 48,000 camera images (mostly taken in the Silicon Valley area in the United States) and over 16,000 LiDAR scan images, which are annotated with 28 classes, including pedestrians, passenger cars, bicycles, construction site signs, traffic signs, or trucks, etc.

Moreover, the LiDAR point cloud image may be visualized to suit a user's desired options by using point cloud task tools such as Open3D™. Because the LiDAR 120 is capable of detecting a distance, 3D LiDAR images may be realistically reproduced in visual processing with Open3D™, for example, in a method in which objects farther away are colored in dark blue, and objects closer are colored in light blue (e.g., to assist in scene labeling, interactive annotation, or quality checking, etc.).

Furthermore, as mentioned above, the original LiDAR image (i.e., raw data) may be pre-processed by applying a technique called voxel (three-dimensional pixel) down sampling to the LiDAR point cloud image. Here, the voxel refers to a cube-shaped 3D pixel. The voxel down sampling is a technique for reducing the number of points in the LiDAR point cloud without requiring excessive AI computation while the structure of the various objects in the cloud is preserved (e.g., vehicle contours, pole shapes, or low ceiling profiles, etc.).

For example, the LiDAR 120 emits ‘m’ laser beams ‘n’ times during one scan cycle. In this case, scan values of the laser beams that collide with an external object and return form an m×n matrix. Data of the m×n matrix is called a range image. Each point constituting the LiDAR point cloud image includes depth (i.e., range) information, and also includes the intensity, azimuth, and inclination of the returned laser pulse (e.g., to help classify materials, estimate reflectivity, or filter out noise, etc.) and other additional information. For range images, AI training is possible by using large datasets such as Waymo™ Open Dataset (WOD), for example.

In short, range view (RV) is a technique that converts a three-dimensional point cloud into a two- to two-and-a-half-dimensional scene, and represents the converted result as a LiDAR three-dimensional map that humans are capable of intuitively understanding like an analog painting instead of a lot of dots. In the range view image, the 3D LiDAR point cloud image has 2D coordinates. However, the 3D laser-related information (e.g., an angle, an inclination/slope, intensity, or reflectivity, etc.) recorded during acquisition of the range image is retained and not discarded. When one coordinate of one 2D axis is obtained by applying a variable of a width to the (x, y) coordinate among (x, y, z) coordinate values of the 3D LiDAR image, and the other coordinate of the other 2D axis is obtained by applying a variable of a height and range image information indicating a range (depth) to the (z) coordinate, a 2D range view image is created (e.g., for CNN-based object detection, semantic segmentation, or trajectory prediction, etc.).

In addition, the AI algorithm according to an example of the present disclosure may include a convolutional neural network (CNN), which is a deep learning model used for image recognition, segmentation, or object detection tasks, etc. The CNN is an AI training module frequently used to extract features (or feature points) from image data. To this end, there are commercially available datasets composed of tens of thousands of images (e.g., KITTI, nuScenes, or ApolloScape, etc.). Currently, the CNN has a version capable of processing images from 1D to 3D. That is, the results of a range view image processing tool are trained by the CNN to perform a function of helping AI accurately recognize an object in an image.

Because an object around an autonomous vehicle is finally recognized by the machine, an operation of creating a ground truth (GT) bounding box on the aforementioned LiDAR map is also an important process in object recognition (e.g., drawing a labeled box around a car, a pedestrian, a cyclist, or a road sign, etc.). In machine learning, the GT is a term used to indicate an original value or an actual value of data to be trained by the AI. It may be a type of image annotation applied to the LiDAR point cloud image as a bounding box usually in the form of a box-shaped boundary surrounding a known object (e.g., a vehicle, pedestrian, sign, or pole, etc.).

That is, to recognize an object, the AI module fetches a label and then groups various objects. Of course, an interval between 3D data points used to output a GT bounding box may also be set. One GT bounding box may be set to include between 50 to 1000 LiDAR cloud points (e.g., depending on object size, resolution, or annotation standards, etc.).

Of course, such the GT annotation is not present in raw data captured by a sensor such as the LiDAR 120 while a vehicle is driving. The processor 110 needs to recognize a target belonging to various classes such as road signs, crosswalks, pedestrians, another vehicle, or a center line, etc., as an object. The GT annotation is a means used to measure object recognition errors by comparing the object determination results recognized by the AI algorithm of the processor 110 with an actual object (e.g., a labeled pedestrian, vehicle, traffic sign, or lane marking, etc.) and to sometimes evaluate AI performance, for example, in terms of accuracy, recall, precision, or intersection-over-union (IoU), etc. The GT bounding box applied to an original image in an annotation form may be set manually by a user, but there are also commercially available GT calculation tools, such as grid-striding or polygon interpolation, etc.

When an AI object recognition module is executed, the predicted bounding box may also be identified. The result recognized by the processor 110 as an object of a specific class from the original image data obtained from the LiDAR sensor 120 is displayed in the shape of another bounding (e.g., for a detected vehicle, pedestrian, bicycle, or roadside object, etc.) box similar to the GT bounding box but derived from AI inference rather than manual annotation. The predicted bounding boxes, unlike GT bounding boxes, are the computational results of autonomous driving AI models. The predicted bounding box may match the GT bounding box, but there may be an area that does not match or overlap the GT bounding box at all (e.g., due to occlusion, poor resolution, or model inaccuracy, etc.).

For reference, only the predicted bounding boxes may not definitively determine whether an object of a specific class is actually present at a specific location, and thus the predicted bounding boxes are usually called probability boxes (P-Boxes) (e.g., for pedestrians, vehicles, traffic cones, or bicycles, etc.) or predicted bounding boxes. This reflects the fact that these boxes are generated based on model confidence rather than confirmed ground truth.

For example, segmentation processing performed after pre-processing refers to displaying a specific part of a road (e.g., a traffic light, a pedestrian crosswalk, a stop sign, or a construction barrier, etc.) in red and the rest (e.g., an asphalt road, a sidewalk, a curb, or a lane marking, etc.) in blue. At this stage, the AI module may also perform clustering of the point cloud into specific groups based on semantic similarity or spatial proximity (e.g., grouping vehicles, lane boundaries, pedestrians, or road furniture, etc.), and generate predicted bounding boxes (P-Boxes) for object candidates. Clustering a point cloud into specific groups and generating P-Box may also be performed at the segmentation stage. For reference, there is also a technique called cluster expansion. Here, an expansion target may include a cluster up to all points within an epsilon distance (a minimum distance for forming a cluster) from a seed point (e.g., to ensure small object boundaries are not missed, or to improve classification confidence, etc.).

During segmentation processing, P-Box creation and clustering based on the point cloud are performed. For example, the AI network performing segmentation is used to obtain a semantic point label from the LiDAR sensor 120 (e.g., labeling points as car, road, vegetation, or pedestrian, etc.).

To solve a ground recognition error occurring during the segmentation, the present disclosure proposes “rule-based” ground recognition and a label fusion technique. Any of various techniques such as slope-based ground recognition, grid-based ground recognition, or other non-planar-based ground recognition (e.g., histogram-based, region-growing, or elevation-map-based methods, etc.) may be applied as the ground recognition algorithm. However, the present disclosure proposes to adopt the slope-based ground recognition technique when the ground inside a tunnel is recognized (e.g., due to the varying slope or curvature of tunnel floors, which planar models may fail to accommodate).

For reference, semantic segmentation refers to a task of assigning a unique class label to each point in the point cloud generated by the LiDAR 120. In the LiDAR-based image processing technology, the semantic segmentation enables the extraction of meaningful information from LiDAR data for object recognition and scene reproduction, which are necessary for implementing autonomous driving. Various semantic segmentation AI models (e.g., a projection-based method, a point-based method, and a sparse convolution-based method, or a range-image-based method, etc.) may be applied. For example, the semantic segmentation result may be the result of AI computation performed by the processor 110 and a dedicated processing platform such as NVIDIA DRIVE™ AGX system. With this configuration, for example, various colors may be added to the LiDAR point cloud image to distinguish object classes (e.g., red for vehicles, blue for roads, green for pedestrians, or yellow for traffic signs, etc.).

After the segmentation process as above, the LiDAR image goes through a post-processing process. The post-processing refers to converting point cloud data into a 3D map or a model, which is meaningful information for autonomous driving. The post-processing process also includes removing residual noise and correcting errors from a LiDAR point cloud image, recognizing an object such as a vehicle or a pedestrian from the point cloud, and attaching and registering a unique identifier to point cloud information as necessary (e.g., assigning a tracking ID to each detected vehicle or pedestrian, etc.).

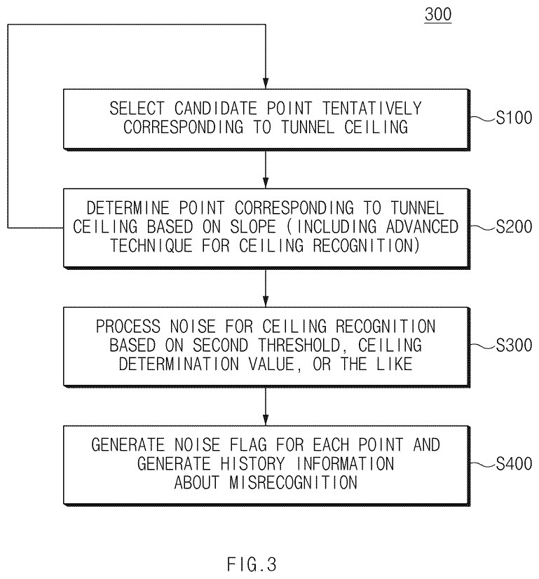

Next, FIG. 3 shows an example of an algorithm 300 for recognizing an inside structure 200 of a tunnel by using point data recognized from the LiDAR 120 and an AI module, according to an example of the present disclosure.

The core of the algorithm 300 according to an example of the present disclosure may be simply expressed as a slope-based removal technique (e.g., filtering LiDAR points with steep angles such as tunnel walls or overhanging structures, etc.). The present disclosure refers to a method for estimating the shape of a point having a specific height or higher as the ceiling of a tunnel (i.e., as a candidate point) by using a longitudinal slope feature of an upper channel used by the LiDAR 120, and additionally removing a point one by one when it is determined through additional verification that one of the candidate points does not correspond to the ceiling, and determining LiDAR point data corresponding to the tunnel ceiling 230. This approach helps mitigate the mis-clustering phenomenon caused by the low tunnel ceiling 230 (e.g., mistakenly identifying the ceiling as a forward obstacle), which may occur while an autonomous vehicle is driving.

As mentioned above, because a LiDAR valid point, which is not present, is generated when the ceiling 230 of the tunnel 200 is low, the LiDAR valid point may be misrecognized as a front object (e.g., a stopped vehicle or a traffic barrier, etc.). When this recognition error is removed by using only the height of the point, the object may not be recognized on a general road with a slope (e.g., an uphill ramp, a curved overpass, or an inclined tunnel entrance, etc.). In general, the LiDAR 120 collects point cloud data by using, for example, a total of 16 channels. Whether there is misrecognition is determined by using the inclination (i.e., slope) information of each point recognized in an upper channel (e.g., the top 4 channels out of 16 channels that face toward the ceiling or elevated surfaces, etc.) among the total of 16 channels.

For reference, in the case of the present disclosure, the following ground-related pre-processing and segmentation task may be performed prior to performing S100 illustrated in FIG. 3.

That is, the present disclosure also pays attention to the phenomenon that the ground 210 is not properly recognized as the ground inside the tunnel 200 (e.g., due to uneven road surfaces, dim lighting, or reflective materials, etc.). Accordingly, the present disclosure proposes to add a slope-based ground subtraction technique to the algorithm 300 to more accurately filter out points likely representing flat surfaces such as the tunnel floor. In detail, when the slope of the point input from the lower channel of the LiDAR 120 satisfies a predetermined ground slope threshold value (i.e., when a point capable of being recognized as a plane is detected from the lower channel) before performing S100, the AI module in the processor 110 according to an example of the present disclosure additionally performs determining that the point is a point constituting the ground 210, which is unlikely to tentatively correspond to the tunnel ceiling 230 (e.g., the road floor, lane markings, or drainage grates, etc.).

This is a technique that removes points that are not the ground, by indexing point information from the lower channel in the entire point cloud recognized by the LiDAR 120 and calculating the slope of each point to determine whether it meets a planar surface condition (e.g., relatively horizontal surfaces such as paved roads, tunnel floors, or flat shoulders, etc.).

Afterward, in S100 of FIG. 3, a “candidate point” that is tentatively determined to constitute the ceiling 230 is set by accessing point information reflected from the upper channel of the LiDAR 120 among “valid points” determined not to be the ground after the slope-based ground subtraction technique is applied. In this case, a first threshold value (e.g., a threshold value having z value of 3 m for tunnel ceilings, overpasses, or elevated walkways, etc.) for the height in the z-axis direction among an abscissa (x-axis), an ordinate (y-axis), and a vertical axis (z-axis) is set, and points, the height of each of which is lower than the first threshold value, are determined as not being the tunnel ceiling 230. However, as necessary, in addition to the z-axis height, it is also possible to additionally use the width on the x-axis or the length on the y-axis based on a point filtering criterion in S100 (e.g., to eliminate narrow poles, wall-mounted signage, or side beams, etc.). Of course, the first threshold value, threshold values of the width and the height, or the like may vary depending on the type of the tunnel 200 (e.g., rectangular, circular, or arched tunnels, etc.), and optimal threshold value data may be obtained as a vehicle actually is driving through various tunnels 200 while the vehicle is equipped with the LiDAR 120.

In S200, a process is performed to calculate the angle for each longitudinal point by sequentially accessing each point recognized from the upper channel, and recognizing a point having flat slope characteristics as an upper flat surface (e.g., a consistent overhead region without sharp angular variation) (i.e., a relatively flat shape placed at a specific height, such as the tunnel ceiling 230 in FIG. 2) by comparing slope characteristics with adjacent points.

In other words, S200 refers to a method of determining a candidate point whose slope calculated from the upper four channels is greater than or equal to a second threshold value does not correspond to the tunnel ceiling 230, by calculating a slope of each of a plurality of candidate points obtained from S100, and finally identifying the tunnel ceiling 230 by excluding the candidate point from the candidate point list one by one (e.g., filtering out points from steep walls, cables, or suspended ventilation structures, etc.).

In S300, noise processing is performed on points processed in S200 as corresponding to the tunnel ceiling 230 (e.g., through thresholding, outlier detection, or temporal consistency checks, etc.). In S400, it is determined that it does not correspond to the tunnel ceiling 230 when noise processing is performed in units of point (e.g., performed on a per-point basis idue to abrupt changes in slope, inconsistent height, or isolation from neighboring ceiling structures, etc.), and then it is excluded from the aforementioned “candidate point” to generate a corresponding noise flag for each excluded point.

For example, S300 and S400 may include evaluating AI performance as well as performing post-processing for object recognition (e.g., identifying false positives, measuring recognition accuracy, or updating classification confidence scores, etc.). In other words, considering a case where there is a point, which is identified as a tunnel ceiling in S200 but is actually identified not to correspond to the tunnel ceiling 230 (e.g., an overhead sign misclassified due to poor lighting or beam interference, etc.), from among candidate points as misrecognition and generating history information related to the misrecognition may be added to S300 and S400 of FIG. 3 to improve model retraining or performance tuning in future iterations.

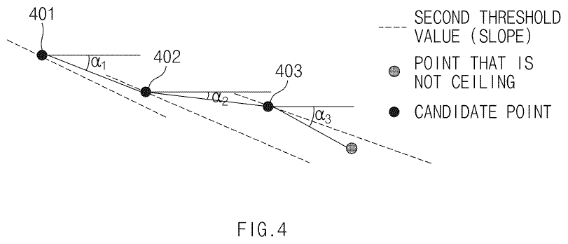

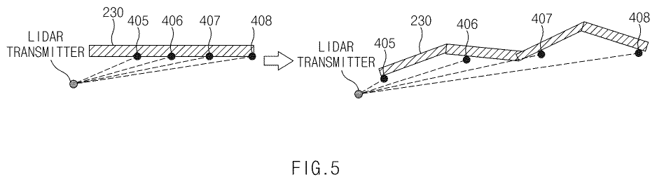

FIGS. 4 and 5 are drawings for describing a technique for further advancing a process of S200 of FIG. 3. That is, FIG. 4 shows an example of a slope measurement principle performed to determine a point corresponding to the ceiling of a tunnel, according to an example of the present disclosure. FIG. 5 shows an example of a principle by which the tunnel ceiling 230 is capable of being accurately measured over time when the algorithm 300 for recognizing the inside structure of the tunnel 200 is applied by using point data recognized from LiDAR and an AI module (e.g., to adaptively track tunnel roof profiles under varying driving conditions such as slopes, curves, or changes in ceiling height, etc.), according to an example of the present disclosure.

In the present disclosure, the most important technology for improving tunnel ceiling recognition is to dynamically adjust or vary the second threshold value described above (e.g., adapting the slope threshold frame-by-frame to reflect structural variations such as arch curvature, ceiling fixtures, or changing tunnel height, etc.). That is, in the present disclosure, the second threshold value may be variable in units of frame of a LIDAR image over time (e.g., frame-by-frame adjustments during vehicle motion in tunnels of varying geometry or elevation, etc.). In particular, the second threshold value thus variable may be determined based on Equation 1 below.

$${slope}_{th} = {weight}_{th} * {slope}_{t - 1} + ( 1 - {weight}_{th} ) * {slope}_{t} \qquad [ Equation 1 ]$$

Here, slopeₜₕ is the second threshold value (e.g., a dynamic cutoff slope used to filter steep points) applied at time ‘t’ (the optimal value may be determined based on actual measurement results or calibration trials); weightₜₕ is a weight measured by using empirical data; slopeₜ is a slope of the candidate point measured at time ‘t’; and slopeₜ₋₁ is a slope of the candidate point measured at time ‘t−1’. In particular, only when the calculated slope is less than the second threshold value corresponding to a ceiling determination value even after slopeₜₕ reaches a ceiling determination value capable of being determined as the tunnel ceiling 230, the candidate point is finally recognized as a tunnel ceiling point (e.g., a flat region directly above the vehicle with consistent slope characteristics over time, etc.).

Accordingly, in FIG. 4, among candidate points 401, 402, 403, and 404 recognized from the upper channel and processed in S100, a candidate point 404 whose slope a (i.e., α1, α2, α3, or the like) exceeds the second threshold value (e.g., based on real-time tunnel geometry or vehicle position, etc.) indicated by the dotted line is excluded from a candidate point list. In other words, a width threshold value, a length threshold value, a Z threshold value (a first threshold value), a ceiling determination value, or the like applied in S100 may be configured to be set differently for each predefined section within a tunnel, even in the same tunnel (e.g., sections with support beams, varying curvature, or lighting differences, etc.).

In addition, an effect like that of FIG. 5 may be obtained by the ceiling recognition enhancement technology according to an example of the present disclosure. That is, the left drawing in FIG. 5 shows a case where the slopeₜₕ variability (e.g., the dynamic adjustment of the slope threshold over time) according to an example of the present disclosure is not applied (e.g., using a fixed threshold for all ceiling point evaluations regardless of tunnel shape or vehicle position, etc.). The slope having the same criterion is applied to all points 405, 406, 407, and 408, and the tunnel ceiling 230 is determined without accounting for temporal or spatial changes. On the other hand, in the right drawing of FIG. 5, not only slopeₜₕ but also the ceiling determination value is variable, it is expected that the exact slope status of the tunnel ceiling 230 is capable of being reflected in real time (e.g., enabling more responsive filtering in irregular or dynamically structured tunnels, etc.).

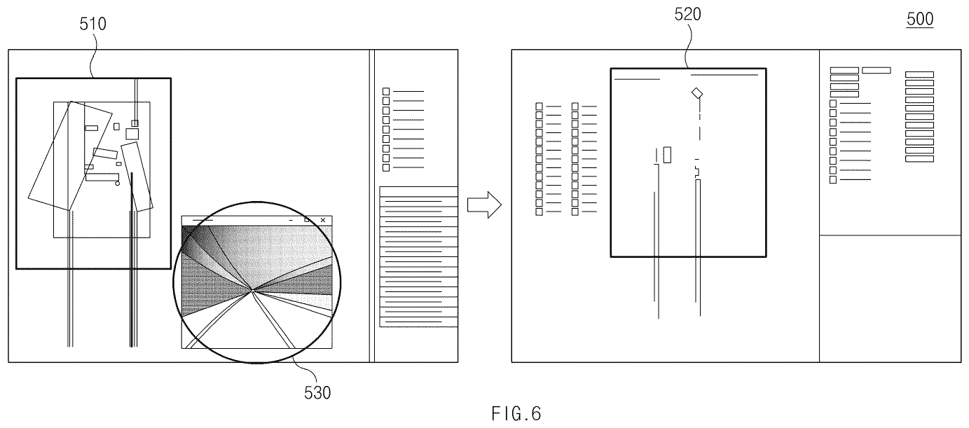

FIG. 6 shows an example of an actual experimental result 500 in which misrecognition inside a tunnel is improved by applying an algorithm for recognizing the inside structure of a tunnel by using point data recognized from LiDAR and an AI module (e.g., eliminating false detection of overhead tunnel features as road-level obstacles, etc.).

In other words, it is seen that a portion 510 misrecognized as though the tunnel ceiling 230 is an object on a road in the left drawing of FIG. 6 is improved in the right drawing of FIG. 6 through the application of the present disclosure. For reference, in FIG. 6, reference numeral 530 indicates a road condition actually observed by a front camera (not shown) of a vehicle. As shown in reference 530, there are no objects blocking the road ahead, and thus LiDAR recognition needs to be performed as shown on the right of FIG. 6 (i.e., correctly identifying the space as unobstructed by filtering out ceiling reflections).

FIG. 7 shows an example of a computing system 1000 for autonomous vehicle control and object recognition operations, according to an example of the present disclosure.

Referring to FIG. 7, a computing system 1000 may include at least one processor 1100, a memory 1300, a user interface input device 1400, a user interface output device 1500, a storage 1600, and a network interface 1700, which are connected with each other via a bus 1200 (e.g., a standard communication bus architecture such as AMBA or PCIe, etc.).

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read only memory (ROM) and a random access memory (RAM) (e.g., DRAM, SRAM, or LPDDR5, etc.).

Accordingly, the operations of the method or algorithm described in connection with the examples disclosed in the specification may be directly implemented with a hardware module, a software module, or a combination of the hardware module and the software module, which is executed by the processor 1100. The software module may reside on a storage medium (i.e., the memory 1300 and/or the storage 1600) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM) (e.g., in embedded systems, edge devices, or vehicle-mounted AI units, etc.).

The storage medium may be coupled to the processor 1100. The processor 1100 may read out information from the storage medium and may write information in the medium. Alternatively, the storage medium may be integrated with the processor 1100. The processor and storage medium may be implemented with an application specific integrated circuit (ASIC). The ASIC may be provided in a user terminal (e.g., an automotive embedded control circuit or edge AI inference circuit, etc.). Alternatively, the processor and storage medium may be implemented with separate components in the user terminal.

An example of the present disclosure provides a system and a method for recognizing the inside structure of a tunnel using LiDAR point data and an AI module. An example of the present disclosure provides a system and a method for recognizing the inside structure of the tunnel by using AI such that a LiDAR sensor mounted on a vehicle driving inside the tunnel is capable of accurately recognizing the upper portion of the tunnel, especially a ceiling structure.

The technical problems to be solved by the present disclosure are not limited to the aforementioned problems, and any other technical problems not mentioned herein will be clearly understood from the following description by those skilled in the art to which the present disclosure pertains.

To solve all or at least part of the above-described technical problems, the present disclosure may be implemented in various examples as follows.

According to an example of the present disclosure, the first example of the present disclosure relates to a system that recognizes the inside structure of a tunnel by using point data recognized from a LiDAR and an AI module. That is, a processor equipped with an object recognition module that recognizes an object placed in a surrounding environment from point cloud data generated from the LiDAR as a part of the AI module, and a memory that stores the point cloud data. The AI module performs detecting a plurality of candidate points that are estimated to tentatively correspond to a tunnel ceiling by excluding a point whose height is less than or equal to a first threshold value from among points input from an upper channel of the LiDAR, and calculating a slope for each of the plurality of candidate points to determine that the candidate point, of which the calculated slope is greater than or equal to a second threshold value, do not correspond to the tunnel ceiling, and identifying the tunnel ceiling by excluding the candidate point from a candidate point list.

In the case of the system for recognizing an inside structure of a tunnel by using the LiDAR and the AI module according to the second example of the present disclosure, the second threshold value is variable in units of frame over time.

In the case of the system for recognizing an inside structure of a tunnel by using the LiDAR and the AI module according to the third example of the present disclosure, the second threshold value, which is variable, is determined based on Equation 1:

$${slope}_{th} = {weight}_{th} * {slope}_{t - 1} + ( 1 - {weight}_{th} ) * {slope}_{t}$$

Here, the slopeₜₕ is a second threshold value applied at time ‘t’, the weightₜₕ is a weight measured by using empirical data, the slopeₜ is a slope of the candidate point measured at time ‘t’, and the slopeₜ₋₁ is a slope of the candidate point measured at time ‘t−1’.

In the case of the system for recognizing an inside structure of a tunnel by using the LiDAR and the AI module according to the fourth example of the present disclosure, the AI module performs finally recognizing the candidate point, of which the calculated slope is less than the second threshold value corresponding to a ceiling determination value even after the slopeₜₕ reaches the ceiling determination value capable of being determined as the tunnel ceiling, as a tunnel ceiling point.

In the case of the system for recognizing an inside structure of a tunnel by using the LiDAR and the AI module according to the fifth example of the present disclosure, the AI module performs generating a noise flag for each candidate point excluded from the candidate point list.

In the case of the system for recognizing an inside structure of a tunnel by using the LiDAR and the AI module according to the sixth example of the present disclosure, the AI module performs determining whether a point is the candidate point, by additionally applying a width threshold value and a length threshold value to the point input from an upper channel of the LiDAR when detecting the plurality of candidate points.

In the case of the system for recognizing an inside structure of a tunnel by using the LiDAR and the AI module according to the seventh example of the present disclosure, the AI module additionally performs determining a point as a ground point, which is unlikely to tentatively correspond to the tunnel ceiling, when a slope of the point input from a lower channel of the LiDAR satisfies a predetermined ground slope threshold value before detecting the plurality of candidate points.

In the case of the system for recognizing an inside structure of a tunnel by using the LiDAR and the AI module according to the eighth example of the present disclosure, the AI module additionally performs considering a case where there is a point, which is identified as a tunnel ceiling but is actually identified not to correspond to a tunnel ceiling, from among the candidate points as misrecognition and generating history information related to the misrecognition.

In the case of the system for recognizing an inside structure of a tunnel by using the LiDAR and the AI module according to the ninth example of the present disclosure, the width threshold value, the length threshold value, and the first threshold value are set differently for each tunnel.

In the case of the system for recognizing an inside structure of a tunnel by using the LiDAR and the AI module according to the tenth example of the present disclosure, the width threshold value, the length threshold value, and the first threshold value are set differently for each predefined section within a tunnel, even for an identical tunnel.

According to an example of the present disclosure, a method for recognizing an inside structure of a tunnel by using point data recognized from a LiDAR and an AI module includes detecting a plurality of candidate points that are estimated to tentatively correspond to a tunnel ceiling by excluding a point whose height is less than or equal to a first threshold value from among points input from an upper channel of the LiDAR, and calculating a slope for each of the plurality of candidate points to determine that the candidate point, of which the calculated slope is greater than or equal to a second threshold value, do not correspond to the tunnel ceiling, and identifying the tunnel ceiling by excluding the candidate point from a candidate point list.

The above description is merely an example of the technical idea of the present disclosure, and various modifications and modifications may be made by one skilled in the art without departing from the essential characteristic of the present disclosure.

Accordingly, examples of the present disclosure are intended not to limit but to explain the technical idea of the present disclosure, and the scope and spirit of the present disclosure is not limited by the above examples. The scope of protection of the present disclosure should be construed by the attached claims, and all equivalents thereof should be construed as being included within the scope of the present disclosure.

The present disclosure proposes a method for allowing a LIDAR and AI algorithms to accurately recognize the inside structure of a tunnel in a somewhat dangerous driving environment, that is a tunnel.

That is, the present disclosure first splits point cloud data input from a LiDAR into upper channel input data and lower channel input data. When a slope of a point obtained from the lower channel input data satisfies a ground threshold value capable of being determined to be ground, the present disclosure excludes the point from an additional AI calculation target related to the structure of the tunnel. The exception is taken into account that AI calculation becomes burdensome when a large number of points, including the ground, are used for the tunnel's inner structure calculation while the ground does not correspond to a tunnel.

Moreover, the present disclosure determines that a point, whose slope is greater than or equal to a first threshold value, from among points input from the LiDAR upper channel is not a tunnel ceiling, and excludes the point from a tunnel ceiling candidate, thereby improving reducing the burden of the tunnel ceiling calculation process. For example, the left and right walls inside the tunnel are vertical, and a slope is close to 90 degrees. Accordingly, it is determined that a LiDAR point indicating a great slope does not correspond to a tunnel ceiling structure.

In addition, to accurately recognize an upper portion structure (in particular, a ceiling) of the tunnel, the present disclosure calculates the slope for each point selected as a candidate point and determines whether the slope is greater than a second threshold value. The tunnel is egg-shaped and becomes more circular or oval as it approaches the inside, especially the tunnel ceiling. Accordingly, the top of the tunnel may have a near-planar shape. This means that the slope of the LiDAR point is very low.

However, it is assumed that the present disclosure is applied in real time in an environment where a vehicle drives inside a tunnel. Accordingly, the present disclosure determines that the height of the internal shape (in particular, a ceiling) of the tunnel may vary for each tunnel, each tunnel section, and over time. Accordingly, the second threshold value for determining the tunnel ceiling may be set differently at each time at which the LiDAR image frame is entered. An AI algorithm is built such that weights reflected by measuring unique shape characteristics of each tunnel become parameters that affect the variability of the second threshold value.

Besides, through the detailed description of the present disclosure and the attached drawings, those skilled in the art may understand various effects other than the effects described above from the present disclosure.

Hereinabove, although the present disclosure has been described with reference to examples and the accompanying drawings, the present disclosure is not limited thereto, but may be variously modified and altered by those skilled in the art to which the present disclosure pertains without departing from the spirit and scope of the present disclosure claimed in the following claims.

What is claimed:

1. An apparatus of a vehicle, the apparatus comprising:
a processor; and
a memory storing at least one instruction that, when executed by the processor communicating with the memory, is configured to cause the apparatus to:
generate, based on sensor data from a sensor of the vehicle, point cloud data representing a surrounding environment of the vehicle,
detect, from the point cloud data, a plurality of candidate points by excluding a point from among points input from an upper channel of the sensor, based on a height of the point being less than or equal to a first threshold value, wherein the plurality of candidate points are points estimated to correspond to a tunnel ceiling,
determine a slope for each of the plurality of candidate points,
exclude, from the plurality of candidate points, each candidate point having the determined slope being greater than or equal to a second threshold value,
identify, based on the remaining candidate points and based on a learning model stored in the memory, the tunnel ceiling,
output a signal indicating the identified tunnel ceiling, and
control, based on the signal, autonomous driving of the vehicle.

2. The apparatus of claim 1, wherein at least one instruction, when executed by the processor communicating with the memory, is configured to cause the apparatus to:
identify an adjacent point located in a traveling direction of the vehicle, and wherein the slope is determined based on a height difference between a candidate point and the adjacent point and based on a horizontal distance between the candidate point and the adjacent point, and
identify, based on the remaining candidate points input into the learning model, the tunnel ceiling.

3. The apparatus of claim 1, wherein the second threshold value is a variable in units of frame over time, and wherein the second threshold value is determined based on the following equation:
$${slope}_{th} = {weight}_{th} * {slope}_{t - 1} + ( 1 - {weight}_{th} ) * {slope}_{t} ,$$
and
wherein the slopeₜₕ is a second threshold value applied at time ‘t’, the weightₜₕ is a weight measured by using empirical data, the slopeₜ is a slope of a candidate point measured at time ‘t’, and the slopeₜ₋₁ is a slope of the candidate point measured at time ‘t−1’.

4. The apparatus of claim 3, wherein the at least one instruction, when executed by the processor communicating with the memory, is configured to cause the apparatus to recognize, as a tunnel ceiling point, a candidate point whose measured slope is less than the second threshold value corresponding to a ceiling determination value, even after the slopeₜₕ reaches the ceiling determination value.

5. The apparatus of claim 1, wherein the at least one instruction, when executed by the processor communicating with the memory, is configured to cause the apparatus to generate a noise flag for each candidate point excluded from the plurality of candidate points.

6. The apparatus of claim 1, wherein the at least one instruction, when executed by the processor communicating with the memory, is configured to cause the apparatus to detect the plurality of candidate points based on applying a width threshold value and a length threshold value to the points input from the upper channel of the sensor.

7. The apparatus of claim 1, wherein the at least one instruction, when executed by the processor communicating with the memory, is configured to cause the apparatus to, before detecting the plurality of candidate points, determine, based on a slope of a first point satisfying a predetermined ground slope threshold value, the first point as a ground point, wherein the first point is from among points input from a lower channel of the sensor, and wherein the ground point is a point estimated not to correspond to the tunnel ceiling.

8. The apparatus of claim 1, wherein the at least one instruction, when executed by the processor communicating with the memory, is configured to cause the apparatus to generate about history information misrecognition, wherein the misrecognition corresponds to a case where there is a point, which is incorrectly identified as a tunnel ceiling point of the tunnel ceiling.

9. The apparatus of claim 6, wherein the width threshold value, the length threshold value, and the first threshold value are set differently for each tunnel of a plurality of tunnels having tunnel ceilings.

10. The apparatus of claim 9, wherein the width threshold value, the length threshold value, and the first threshold value are set differently for each of a plurality of predefined sections within a tunnel having the tunnel ceiling.

11. A method performed by an apparatus of a vehicle, the method comprising:
detecting a plurality of candidate points by excluding a point from among points input from an upper channel of a sensor of the vehicle, based on a height of the point being less than or equal to a first threshold value, and wherein the plurality of candidate points are points estimated to correspond to a tunnel ceiling;
determining a slope for each of the plurality of candidate points;
excluding, from the plurality of candidate points, each candidate point having the determined slope being greater than or equal to a second threshold value;
identifying, based on the remaining candidate points and based on a learning model stored in a memory of the vehicle, the tunnel ceiling;
outputting a signal indicating the identified tunnel ceiling; and
controlling, based on the signal, autonomous driving of the vehicle.

12. The method of claim 11, wherein the determining of the slope for each of the plurality of candidate points comprises:
identifying an adjacent point located in a traveling in direction of the vehicle;
based on a height difference between a candidate point and the adjacent point and based on a horizontal distance between the candidate point and the adjacent point, determining, as the slope, a slope between the candidate point and the adjacent point; and
identifying, based on the remaining candidate points input into the learning model, the tunnel ceiling.

13. The method of claim 11, wherein the second threshold value is a variable in units of frame over time, and wherein the second threshold value is determined based on the following equation:
$${slope}_{th} = {weight}_{th} * {slope}_{t - 1} + ( 1 - {weight}_{th} ) * {slope}_{t} ,$$
wherein the slopeₜₕ is a second threshold value applied at time ‘t’, the weightₜₕ is a weight measured by using empirical data, the slopeₜ is a slope of a candidate point measured at time ‘t’, and the slopeₜ₋₁ is a slope of the candidate point measured at time ‘t−1’.

14. The method of claim 13, further comprising:
recognizing as a tunnel ceiling point, a candidate point whose measured slope is less than the second threshold value corresponding to a ceiling determination value even after the slopeₜₕ reaches the ceiling determination value.

15. The method of claim 11, further comprising:
generating a noise flag for each candidate point excluded from the plurality of candidate points.

16. The method of claim 11, wherein the detecting of the plurality of candidate points comprises:
detecting the plurality of candidate points by applying a width threshold value and a length threshold value to the point input from the upper channel of the sensor.

17. The method of claim 11, further comprising:
before the detecting of the plurality of candidate points, determining, based on a slope of a first point satisfying a predetermined ground slope threshold value, the first point as a ground point, wherein the first point is from among points input from a lower channel of the sensor, and wherein the ground point is a point estimated not to correspond to the tunnel ceiling.

18. The method of claim 11, further comprising:
generating history information about misrecognition, wherein the misrecognition corresponds to a case where there is a point, which is incorrectly identified as a tunnel ceiling point of the tunnel ceiling.

19. A method performed by an apparatus of a vehicle, the method comprising:
obtaining, from a sensor of the vehicle, data representing a surrounding environment of the vehicle;
filtering the data to exclude points having a height less than or equal to a first threshold value, to generate a plurality of candidate points;
for each of the plurality of candidate points, identifying an adjacent point located in a traveling direction of the vehicle and determining a slope between a candidate point and the adjacent point, wherein the slope is determined based on a height difference between the candidate point and the adjacent point and based on a horizontal distance between the candidate point and the adjacent point;
removing, from the plurality of candidate points, each candidate point having a slope greater than or equal to a second threshold value, to obtain a plurality of ceiling points;
identifying, based on the plurality of ceiling points input into a learning model stored in a memory of the vehicle, a tunnel ceiling;
generating a signal indicating the identified tunnel ceiling; and
controlling, based on the signal, autonomous driving of the vehicle.

20. The method of claim 19, further comprising, prior to generation of the plurality of candidate points:
identifying, based on a ground slope threshold value, one or more ground points from the data; and
excluding the one or more ground points from the data.
